(19) United States
(12) Patent Application Publication
(10) Pub. No.: US 2006/0041620 A1
(43) Pub. Date: Feb. 23, 2006

(54) Method and system for co-joining computational spacecells in a networked environment

(76) Inventor: Ian R Nandhra, Sonora, CA (US)

Correspondence Address: BEYER WEAVER & THOMAS LLP, P.O. BOX 70250, OAKLAND, CA, 94612-0250, US

(21) Appl. No.: 10/483,022

(22) PCT Filed: Jul. 5, 2002
(86) PCT No.: PCT/US02/21407

§ 371 Date: Jan. 5, 2004

Related U.S. Application Data
(60) Provisional application No. 60/303,347, filed on Jul. 5, 2001.

(51) Int. Cl. G06F 15/16

(52) U.S. Cl. 709/206

(57) ABSTRACT

A system, method and apparatus providing the creation, management and usage of a non-distributed computational and storage Space environment in the field of networked devices, specifically computational and storage devices. Mechanisms are provided to facilitate the merging of Space environments across dissimilar and security protected networks such that the merged Space environments act as a logically and operationally contiguous environment. Also disclosed is a system and method to use Space environments in the field of Transaction Servers with particular attention being made to Application Servers such as can be found on the Internet.

### TECHNICAL FIELD

The present invention relates to a method of joining computational and storage Space Cells in a networked environment and, in particular, to methods relating to the ways in which such co-joined cells interoperate with each other and to other systems connected to the cells.

The present invention further relates to a method of entangling co-joined computational and storage Space Cells in accordance with an operational policy.

### BACKGROUND

The increasing power of desktop systems has given rise to the widespread situation where such desktop systems acting as Clients in the traditional Client/Server model are more powerful in terms of storage and computational ability than the server they are communicating with. Those skilled in the art will be familiar with the concepts of Client Server and Peer to Peer (P2P).

Additionally, the increased availability of high-speed data networks such as Cable Modem Internet connections means that Client systems often have a better network bandwidth availability than the server or servers being connected to. These and other technological advances have given rise to a popular information sharing technology called Peer to Peer or P2P. In a P2P system, Client systems can communicate directly with each other after previously contacting a server to establish specific rules of access. P2P systems suffer from specific disadvantages:
the inability to cope with increasing use,
the use of centralized servers,
lack of fault-tolerance
the inability to share computational tasks between clients.
forcing Clients to know where data is coming from and where it should be stored.
Reliance on reliable network connections (i.e. those that do not suffer from frequent network disconnects such as wireless devices).

Clearly, a system of inter-connected Client computers that share data, share computational power and other resources while allowing users to access data and perform computation tasks in a manner that did not require the users to actively specify where their data was stored has widespread application in fields such as:
Information discovery and sharing
Application server transactions in unreliable network environments (such as wireless).
Computation resource pooling
Applications where data needs to be stored for later asynchronous retrieval.

The JavaSpaces technology from Sun Microsystems provides a broad framework for the interconnection of Client systems to a shared environment termed Space. Systems connected to Space share a common messaging area containing data and computational instructions in objects called templates. Connected Clients can send data into Space by first encapsulating the data into a template and then writing the template to Space. Such templates can then be accessed or modified by other connected clients at a future time. A limitation of the JavaSpaces framework relates to the inability of the Space environment to extend across firewalled devices as can be found in very extensive use in networks such as the Internet. As a result, the Space environment is restricted to local networks (also termed sub-nets) only.

### BRIEF DESCRIPTION OF THE DRAWINGS

FIG. 1. A diagram showing the various components of a simple electronic computer which embodiments could use to facilitate operation of the invention.

FIG. 2 A diagram showing a basic Space Cell Clerver Arrangement

FIG. 3 A diagram showing Space Server Negotiation

FIG. 4 A diagram showing the how a plurality of Space Cells are Co-joined into a one logically contiguous Space Cell

FIG. 5 A diagram showing Inter-Space Communication

FIG. 6 A diagram showing Simple template locking and access negotiations.

FIG. 7 A diagram showing the Simple Transaction/Application Server Transaction

FIG. 8 A diagram showing Simple Transaction/Application Server Transaction using Space Cells

FIG. 9 A diagram showing Space Cells and Space Clusters.Detailed

### DESCRIPTION

In accordance with one broad aspect, the present invention provides a mechanism to co-join many Space environments (called Space Cells) into a larger Space Cell across firewalled devices (i.e. across the Internet) and to address unreliability issues such as network failures and the failure of systems attached to the cells.

In accordance with another broad aspect, the present invention provides a mechanism for the negotiation of Space Servers based of properties, abilities and other characteristics apparatus dependent on the needs of the specific embodiment.

In accordance with another broad aspect, the present invention provides a failure recovery and Space Server mirroring such that one of a plurality of functionally and operationally similar Space Servers can take the place of one or more failed Space Servers.

In accordance with another broad aspect, the present invention provides a mechanism for the entanglement of Space Cells such that the contents of a plurality of Space Cells can be merged together in accordance with the needs of the specific embodiments such that the merged cells operate as one logically contiguous cell. Additional mechanisms are provided to separate entangled cells into a plurality of identical or similar independently operating Space Cells.

In accordance with another broad aspect, the present invention provides a mechanism for Transaction Servers such as Application Servers to use Space Cells to store transactions, intermediate data, results sets and other such information and computational code as may be required.

As used herein, the term “Client” and “Server” is meant broadly and not restrictively, to include any device or machine capable of accepting data, applying prescribed processes to the data, and supplying results of the processes. As used herein, the term “Clerver” is meant broadly and not restrictively describe a combination of client and server devices.

As used herein, the term Space Cell is meant broadly and not restrictively, to include a collection of devices, machines or Clerver capable of connecting together, such connections being optionally controlled by a single or plurality of Cell Servers.

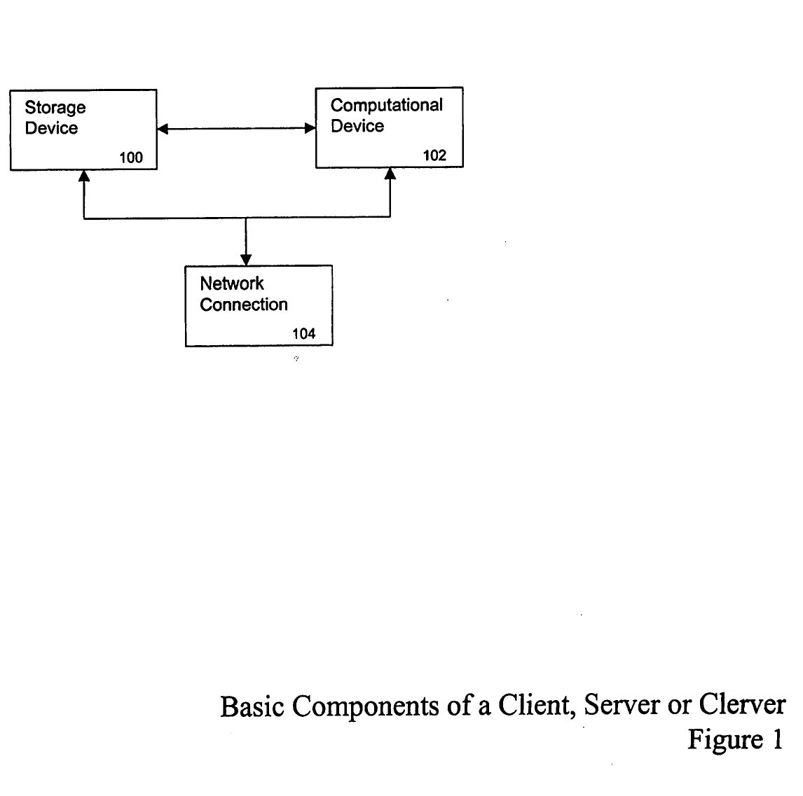

The specific nature of a Client, Server and Clerver will vary between the specific embodiments, but in the preferred embodiment they will comprise at least the devices shown in FIG. 1. In general, the terms “client”, “server” and “clerver” can be though of as follows. The term Client is used to describe systems that cannot easily share their stored information, internal components and functionality and externally connected components with other systems. Typically, Clients connect to Servers to access the Servers stored information and other components and functionalities. The term Server is used to describe systems comprising large amounts of storage and computational power compared with that contained within Client systems that is dispensed to a client in response to an information request by a client. Clervers are devices that combine the ability to gather, process and share data with clients and other clervers. A “clerver” is a combination of client and server components and functionality. In some embodiments, the Clerver's Client connects to Servers, other Clerver's Server's or even its own Server. A Clerver may also act independently, its Client connecting to its Server. The scope and nature of the possible Clerver interconnections are only limited by the needs of a particular embodiment and should in no way be considered limited to that in this example.

The storage device 100 is used to store such data and executable programs as are required by the computation device 102 and for correct operation of the specific embodiment. The networking device 104 interconnects between the computation device and the storage device. While only three simple devices have been shown, many embodiments will include other devices such as input devices (keyboard, mouse), viewing devices (display screen), persistent storage (such as hard disks and other non-volatile storage devices) and other devices as are required by the specific embodiments.

Due to the nature of the Space environment as described by aspects of this invention, the differences between Client and Server as are commonly applied in the art become indistinct. The term Clerver as used in this invention could equally well apply to a Client or a Server insofar as they contain the basic devices described in FIG. 1.

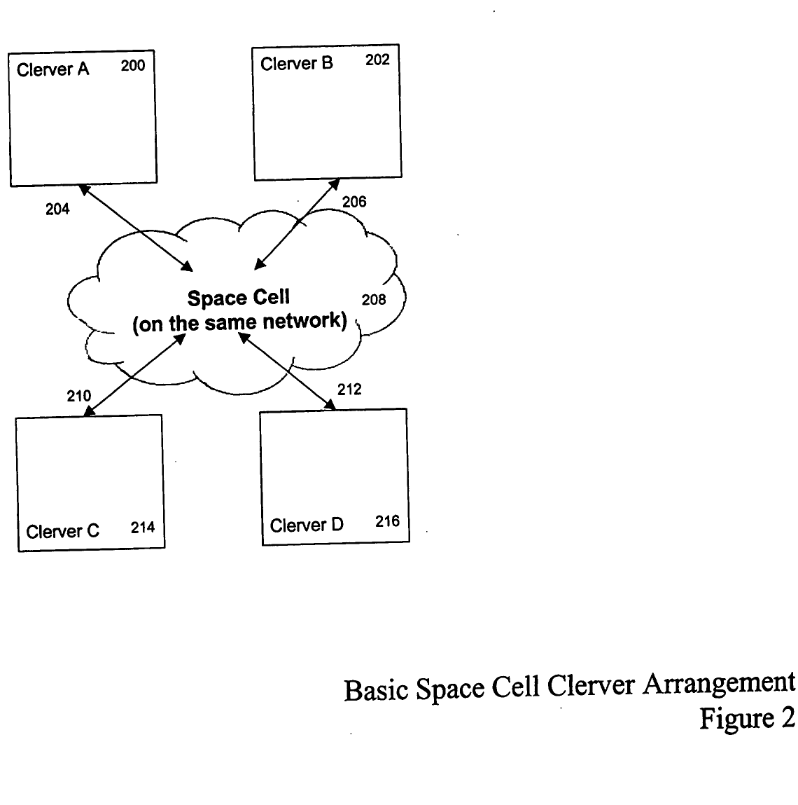

With reference to FIG. 2, we see a number of Clervers 200, 202, 214 connected to a Space Cell 208 by reliable network connections 204, 206 and 210 and Clerver 216 connected to the Space Cell 208 by unreliable network connection 212. The term “reliable network connection” is one that suffers from relatively low levels of error in the transmitted data and/or very few physical disconnections. Examples of reliable network connections include T1 and DSL networks. The term “unreliable network connection” is one that suffers from relatively high errors in the transmitted data and/or many physical disconnections. Examples of unreliable network connections include modems and wireless devices. The concept of “reliable” only has meaning when applied to a specific instance or situation. A Space Cell is controlled by a Space Server and Clervers wishing to access the Space have to register with a controlling Space Server. The number of Clervers that can register with a Space Server is only limited by the abilities of specific embodiments. As shown in FIG. 2, Clerver 202 is designated as the “Space Server” for Cell 208. Such “Space Server” designation is dependent on the needs of the specific embodiment, but in the preferred embodiment, the Space Server contains fast storage and computational abilities in addition to having a fast network connection. In the preferred embodiment Clerver 212 is unsuitable as the Space Server since it is connected to the Space Cell via an unreliable network connection. In some embodiments, the attached Clervers negotiate which is best suited to be the Space Server, consideration being given to the computational power, storage abilities and network type and speed. The manner of such negotiation and the abilities of the individual Clervers is dependent on the needs of the specific embodiments. In the preferred embodiment, each attached Clerver is capable of being the Space Server irrespective of which Clerver has been designated or negotiated as the Space Server.

With reference to FIG. 2, consideration is now given to the way in which the Clervers connect to the Cell. Since Clerver 202 is designated as the Space Server, Clervers 200, 214 and 216 have to wait until Clever 202 has established the Cell before they register with the Space Server. In the case of Sun Microsystems' JavaSpaces, this registration consists of network broadcast messages to establish if a Space Server is available, the Clervers repeating the broadcast until a Space Server is found or some other embodiment specific condition is encountered. However, the manner in which the Clervers contact the designated Space Server should in no way be considered limited to this example.

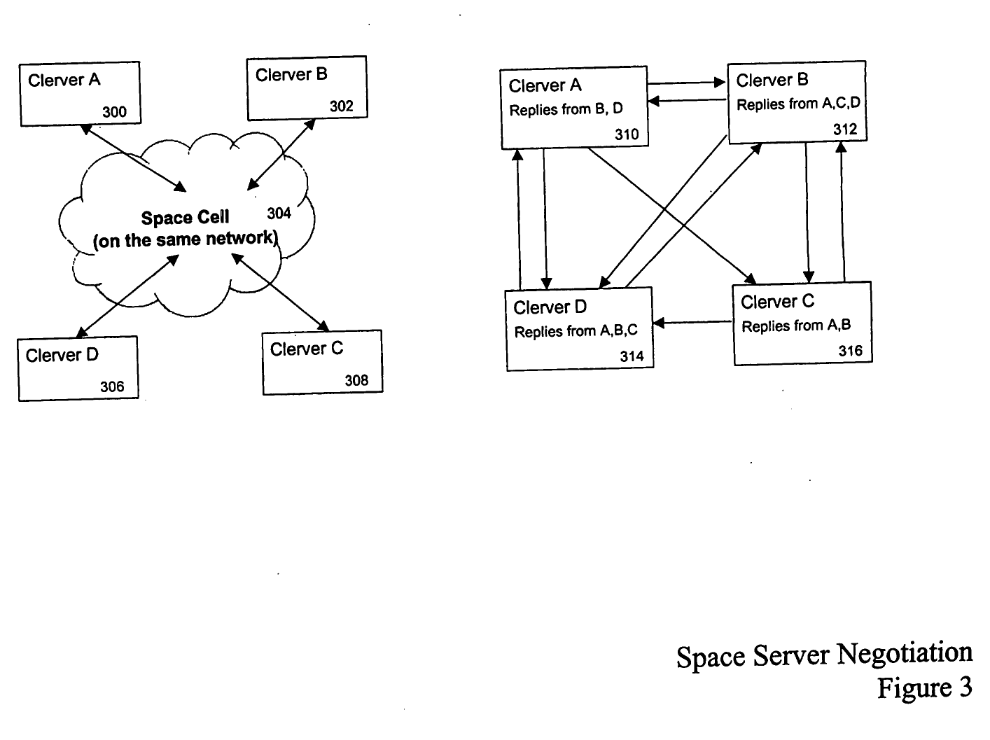

In FIG. 3, Clervers 300, 302, 306 and 308 negotiate who will be the Space Cell (304) Server. Although there are numerous possible methods for performing such negotiation, Clervers in preferred embodiments broadcast their capabilities and policy encapsulated in a “Negotiation Object” to all other clervers in the connected network. The Negotiation Object describes the abilities of the Clerver in a manner that can be compared with the Negotiation Object of other Clervers or systems to determine which Clerver or System has the best abilities for a particular task. Examples of abilities include, but in no way should be considered restricted to, memory speed, amount of available storage, amount and speed of available computation resources, network bandwidth and network reliability.

In this way, Clervers 300, 302, 306 and 308 each receive an object describing every other Clervers abilities and a policy that establishes the most suitable Space Server. The nature of the policy depends on the requirements of the specific embodiment, but preferred embodiments take into consideration such factors as computational power and speed, amount and speed of storage and the network speed and available bandwidth in addition to a mechanism to resolve the situation where a plurality of Clervers have identical abilities. The nature and scope of this policy should in no way be limited to this example. Once the “Negotiation Object” has been received, the policy is used to determine if the Clerver will be the Space Server or not. In a perfect situation, all Clervers will have received a Negotiation Object from all the other Clervers. However, it is possible that for example during the broadcasts Clerver 316 receives replies from 310 and 312 but not 314 and Clerver 316 receives replies from 310, 312 and not 314. Since none of the Clervers know how many are in negotiation, they do not know how many replies to expect and will give rise to the situation where more than one Space Server has successfully been negotiated in accordance with the received Negotiation Objects. Such situations are typical of unreliable network connections that are commonplace in Space environments.

Resolving such problems is dependent on the needs of the specific embodiment. One embodiment continues to broadcast Negotiation Object's for a period of time. In another embodiment, Clervers request the Negotiation Objects from all responding Clervers to build an overall list of broadcasting Clervers. As used herein, the term “list” is meant broadly and not restrictively, to include a list or any other mechanism, data layout, data structure or storage mechanism capable of providing a random or sequenced series of elements and providing the ability to retrieve a single or plurality of items contained in the list in response to a request for said item or items.

In a preferred embodiment, the policies in received Negotiation Objects are examined to determine if the Clerver was not a Space Server in respect to the Clerver sending the Negotiation Object. Clervers determining that they are not a Space Server discontinue Negotiation Object broadcasts and commence the Space registration process thus reducing the number of Clervers broadcasting Negotiation Objects. This process continues until there are no more received Negotiation Objects at which point the listening Clerver is the Space Server.

Unreliable network connections and other unreliabilities will prevent Clervers from establishing themselves as the Space Server in a somewhat evolutionary survival of the fittest process. Preferred embodiments put a time limit on the negotiation process that may involve repeating the entire cycle from the beginning to establish new lists. This time period also prevents new Clervers from entering the negotiation process thereby continuing it indefinitely. If at the end of this time period, no Space Server has been established, action appropriate to the specific embodiment is taken.

Once a Clerver has established itself as a Space Server, it accepts registration requests from other Clervers and the Space has been established. With reference to FIG. 2, Clervers 200, 202, 214 and 216 can store templates into the Space Cell 208 for later retrieval. For example, Clerver 200 can store a template T0 for later access by Clerver 216 which may take an unknown period of time to retrieve the template since it is connected to the Space Cell 208 by an unreliable network connection. Since templates can contain information, executable program code or other instructions, Clerver 216 could place a template into Space Cell 208 for execution by a specified Clerver or any of the other Clervers connected to the Cell 208 as determined by the needs of the specific embodiment. For example, if Clerver 216 was in actuality a wireless device such as a cell-phone lacking appropriate storage or computational abilities it could encapsulate the description of a task to be performed into a template T216. Clerver 216 can now detach from the Cell 208 while the template T216 is actioned by one or a plurality of Clervers in the Cell. Preferred embodiments include in the template descriptions of the type of resources, such as storage, network bandwidth and computational power that the task requires thus ensuring that the most qualified Clerver actions the template.

In some preferred embodiments, Clervers register with the Space Server for which they were qualified or unqualified to action the template.

The results from the actions contained in template T216 are written back to Cell 208 or directed to another destination as indicated by template T216. In preferred embodiments, the Space Server issues a period message or indicator to the registered Clervers that use this message to prevent re-negotiation of the Space Server. Such period messages are often term heartbeat messages. In the event that Clervers do not receive this periodic heartbeat indicator, the Space Server is assumed to be disconnected and the previously described negotiation process resumes. Preferred embodiments use this heartbeat indicator to prevent previously disconnected Space Server from reattaching to the Cell as the Space Server.

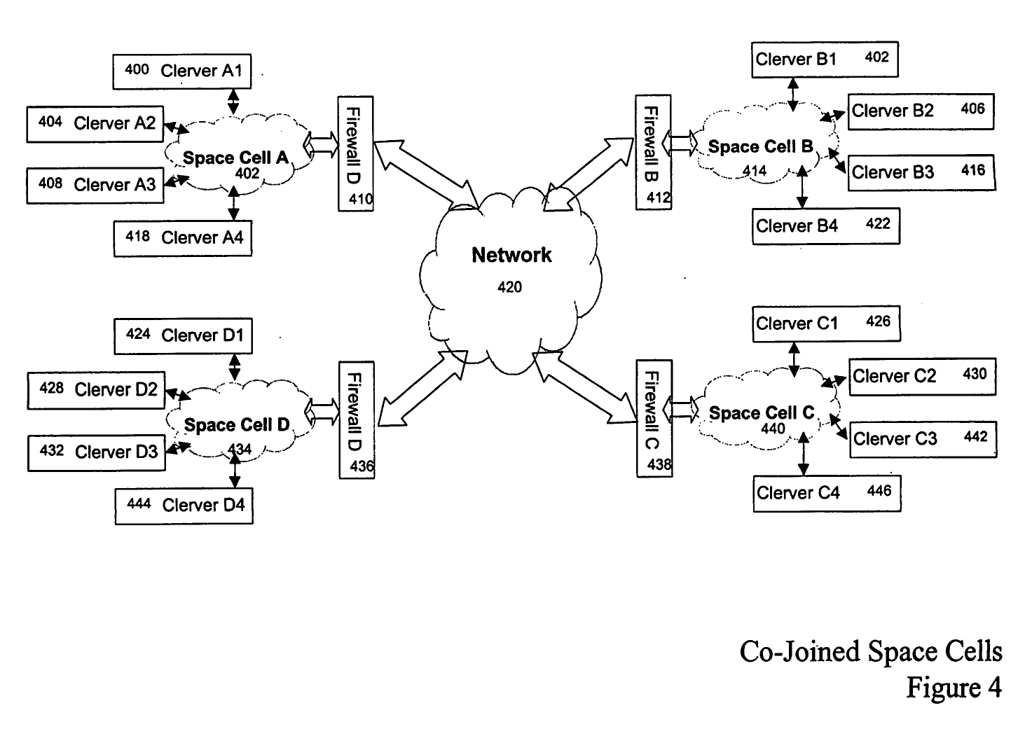

Having described the way in which Clervers form a Space Cell, reference to FIG. 4 shows a number of Space Cells 402, 414, 434, 440 acting as one contiguous space from interconnections through firewalls 410, 412, 436, 438 on a network 420. Each Space Cell 402, 414, 434, 440 connects to the other cells via its respective Space Server, 418, 422, 444, 446. Each of these Space Servers includes an internal device (448) that acts as a Web Server, Application Server or other device capable of accepting connections from the Firewall. Typically for the Internet, these connections will be on Port 80 and will take the form of HTTP commands embedded in URL's although the connections should in no way be considered limited to this example. Particular attention is drawn to the way that templates written to one cell are transferred to the other cells. For example, consider a template T408 written into Cell 402 by Clerver 408. In a co-joined Space environment, this template has an equal chance of being accessed by all Clervers attached to the other cells 414, 434 and 440 that are interconnected through firewalls 410, 412, 436 and 438.

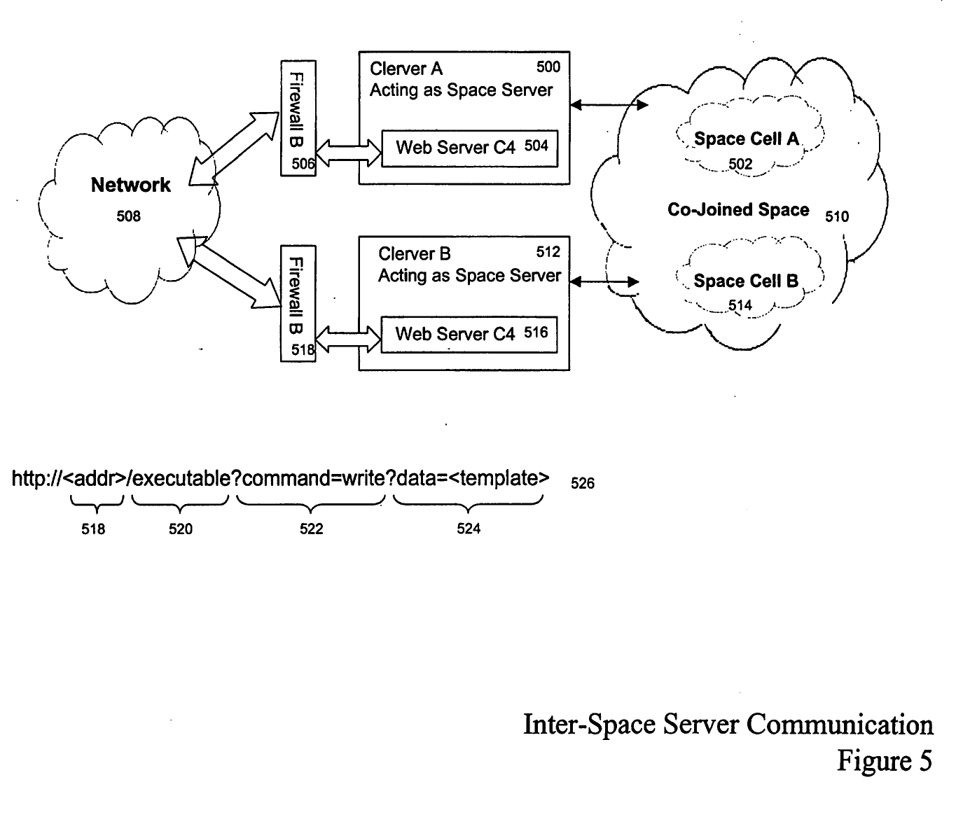

Reference to FIG. 5 shows a data flow between two Clervers 500 and 512. While the exact messaging protocol used between Clervers 500 and 512 will vary between specific embodiments, particular attention is given to a particular embodiment that utilizes the only “open” port—port 80—on firewalls as can be found on the Internet. Clerver 500 wishing to write a template T500 to Cell 514 first forms an HTTP message that encapsulates the template T500 and sends this message to Clerver (512) Web Server 516. An example HTTP message 526 comprises an address 518 that uniquely identifies a single destination Clerver or Server or a plurality of Clervers or Servers, an executable component or plurality of components 520, a command 522 and the template data 524. The number, order, type and specific nature of the HTTP message is dependent on the needs of the specific embodiments and should in no way be considered limited to the example 526.

Upon receiving the template, Clerver 512 issues MIME message to Clerver 500 indicating that the template has been received and including any error information. This MIME message could also contain other information destined for Clerver 500. Clerver 512 writes this template to Cell 514 and performs such other actions as are appropriate for a template write to Cell space such as event triggers etc. Once Clerver 500 has received confirmation from Clerver 512 that the write operation has succeeded, Clerver 500 issues an activate command to Cell 514 using the previously described HTTP message format indicating that template T500 can be accessed.

Consideration is now given to Clerver 512 wishing to read a template from Clerver 500. Admittedly, all templates should be identical between cells 502 and 514, but the operation may be required by some embodiments. Clerver 512 forms an HTTP message requesting the contents of a template T512 in Cell A 502 and sends this message to Clerver (500) Web Server 504. Upon receiving the template, Clerver 500 issues a MIME message to Clerver 512 indicating that the template has been received, including any error information and including the contents of template T512. This MIME message could also contain other information destined for Clerver 512. The format of the read and write commands could be adapted to other needs such as inter-clerver messaging, commands etc as are required by the needs of specific embodiments.

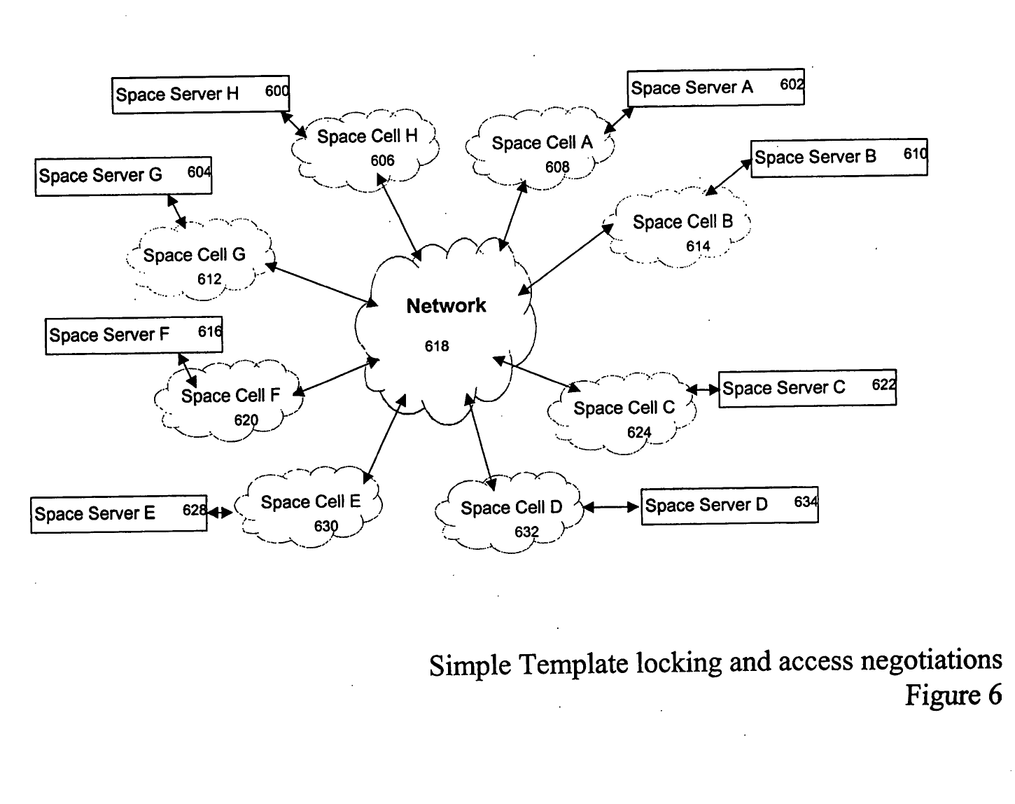

Clervers wishing sole and exclusive use of a template ensure that other Clervers attached to other Space Cells cannot access the specific template. Reference to FIG. 6 shows Space Cells 606, 608, 614, 624, 632, 630, 620 and 612 co-joined by firewall protected unreliable network connections through network 612. With reference to FIG. 6, we will consider the various commands and how the co-joined space cells handle and recover from example errors that could occur. For example, consider Clerver 636 writing template T636 to Cell 630. Using the example messaging protocol previously described, Space Server 628 sends this template to the other Space Servers 600, 602, 610, 622, 634, 616 and 604 and on receiving confirmation from the aforementioned Servers, an activation command is issued. A Clerver attached to Space Cell 632 wishing to delete template T636 first issues a lock command using the example messaging protocol previously described to prevent other Clervers using template T636. Once confirmation of the lock operation has been received, the aforementioned Clerver deletes template T636 with the issuance of a delete command which will delete template T636 from the Cells receiving the delete command. This example of lock-and-perform-action is used for a Clerver to ensure exclusive access to a Template for such operations as:
Template Access
Template deletion
Template modification

and other such operations as are required by the needs of the preferred or specific embodiments.

A plurality of conditions are possible and such failure conditions are essentially permutations of failure to perform the required operation (such as a lock), or obtain confirmation from a destination cell or even failure to establish network connection. Other error conditions are possible and vary between embodiments. The way in which such errors are handled varies between the needs of the specific embodiments. Preferred embodiments provide a “Failure Policy” describing the actions to be taken for the various errors that can occur. Failure Policies can be dynamically changed as needed or may be fixed when the Cell is created.

In this example, consider Server 628 failing to contact Cell Server 600 and the additional lack of confirmation from Server 634. Since there is no way of knowing if Server 600 will ever be contactable or if Server 634 actually received the write command, the write operation to 600 and 634 is retried until successful or some other embodiment specific condition is satisfied (such as a Failure Policy timeout setting).

Space Server 628 now issues an activate command to the responding servers 602, 610, 622, 628, 616, 604. Particular attention is drawn to current condition where write operations are pending to non-contactable servers 600 and 634 and active the templates in the responding cells. Another operation that can be performed is the take operation where a Clerver obtains exclusive access to the template which might optionally be deleted from the Space Cell. Consider Clerver 638 executing a take operation on template T636. Server 634 detects or is instructed that Clerver 638 has issued the Take operation and immediately issues messages to the other connected Cell Servers 602, 610, 622,628, 616 and 604 indicating that template T636 is locked. These messages may optionally contain other information depending on the destination Cell Server or the specific embodiment.

Upon receiving the message, the Space Servers take action in accordance with the specific embodiment—in this example; the template is deleted from the Space. In preferred embodiments, acknowledgements are sent back from the Servers 602, 610, 622, 628, 616 and 604 to Server 634 indicating that the operation has succeeded or that an error has occurred. In other embodiments, no acknowledgements are returned and in another embodiment some acknowledgements are returned. Consider the situation where this acknowledgement has not been received from Server 616. Since there is no way of knowing if Server 616 will ever return or if the Cell 620 will return connected to a different Server, the resolution is left to the specific embodiment, but preferred embodiments would prevent Clerver 638 from having exclusive access to template T636 until the lack of response from Server 616 or Cell 620 is resolved.

In one embodiment, the Server 616 and Cell 620 will be considered permanently disconnected and no further access attempts will be made. In another embodiment, Clerver 638 will continue to access the template and the loss of Server 616 and Cell 620 will be ignored. There are many different permutations of error conditions that could involve a plurality of causes and/or Servers. Consider this situation from the perspective of Server 616 which could be in one of two states: 1) having received the take command and then being unable to send the acknowledgement; 2) not having received the take command. Consider situation 2) where other Clervers attached to Cell 620 could execute commands on template T636 that has previously been locked by Clerver 638. In preferred embodiments, Server 616 will either know that it has lost connection with other cells in the co-joined space either by the failed attempt to send the acknowledgement, from a periodic heartbeat message from the failure to send a take command to the other Servers. This latter situation could result in a paradox in the event that Servers 632 and 616's policy is to ignore the error and allow the requesting Clerver access to the same template. Such paradoxes are a consequence of a plurality of failure conditions involving a plurality of servers, the resolution of which is dependant on the needs of the specific embodiment.

Consideration is now given to the simultaneous access to a template by a plurality of Clervers. In a networked environment, precise synchronization is extraordinarily unlikely, the most common likelihood being that multiple conflicting requests will be received within a short time interval.

The nature of the commands performed and errors encountered will vary between embodiments and should in no way be considered limited to those in the previous description.

Attention is now turned to another aspect of the invention relating to the indexing, cataloging and synchronization of a single Space Cell or a plurality of Space Cells. Indexing the contents of a cell, for example, the templates used in the previous examples, allows a map to be constructed showing where the templates have originated that when combined with usage information from the servers shows where the templates are going. Such information is usable to determine the suitable abilities for a cell server and the space cell. For example, with reference to FIG. 6, if Cell 624's templates are predominantly used clervers in cells 612, 606 and 614, it would be desirable to devote more network resources to these connections. In another example, templates from Cell 620 almost always require a high level of computational power to complete and should be directed to those Clervers best able. Such direction is performed by the Space Servers that share the Indexing information with other Space Servers and Clervers in accordance with the needs of the specific embodiments. The indexing information also provides Clervers with a view of the data contained in the cell templates allowing, for example, a view of web data, unstructured data which may be present in large quantities.

For example, a Clerver wishing to discover information on the Internet may be faced with a very large amount of information, much of which is not relevant to its needs. However, the Clerver may write a template or plurality of templates into a Space cell or co-joined cells describing the data discovery action or actions to be performed. Such templates would have their actioned performed by the Clerver writing the template, another single Clerver or a plurality of Clervers, the discovered results written back into space as they are encountered. The requesting Clerver could index these results templates and select the ones it needs. Unused templates remain in the cell for later access by the requesting Clerver or other Clervers.

Indexing and map information is used to synchronize the templates in a plurality of cells. Ideally, co-joined Space Cells contain identical templates, yet there will be slight differences as new templates are spread around the individual cells. For example, with reference to FIG. 6, it will take a finite period of time for a template written by Clerver 638 to be received by the other Cell Servers and then become available to the cell. Although the “activate” mechanism attempts to synchronize the availability of a template, a Space Index at any given instance will reveal small differences.

Such differences are to be expected in distributed systems and are most usually of minor concern. Preferred embodiments however will synchronize the contents of cells that have become disconnected from the other cells in the co-joined space. Although preferred embodiments will select Space Servers with reliable network connections to other Space Servers (examples of which would include DS1 lines directly connected to the Internet) rather than unreliable network connections (examples of which would include dial-up modems), there are instances where a Cell will become disconnected. The manner in which such disconnects are handled is entirely dependent on the needs of the specific embodiment, however some embodiments may wish to allow the separated cells to continue to function independently of each other until they can be joined together in a “Cell Synchronization” operation. Indeed such operation allows a fragment of the Space to be split off and act independently. Preferred embodiments use Cell Synchronization to allow newly created cells to join a co-joined Space and thus share the existing templates, allow the co-joined Space environment to be cloned for failsafe or backup purposes, or to be copied onto portable devices. Cell Synchronization involves the comparison of the indexes of a plurality of cells that yield a list of duplicate templates between cells and templates that exist in one set of cells but do not exist in another set of cells. The way in which these conflicts are resolved is dependent on the needs of the specific embodiments. For example, one embodiment would delete the duplicate templates, but maintain the different templates in the other cells. Another embodiment would take the list of non-duplicated templates, i.e. those templates that exist in one cell and copy them to the cells that do not contain the templates. The indexing of templates in a Space cell is a security problem that depends more on the access behavior of the Clervers being used.

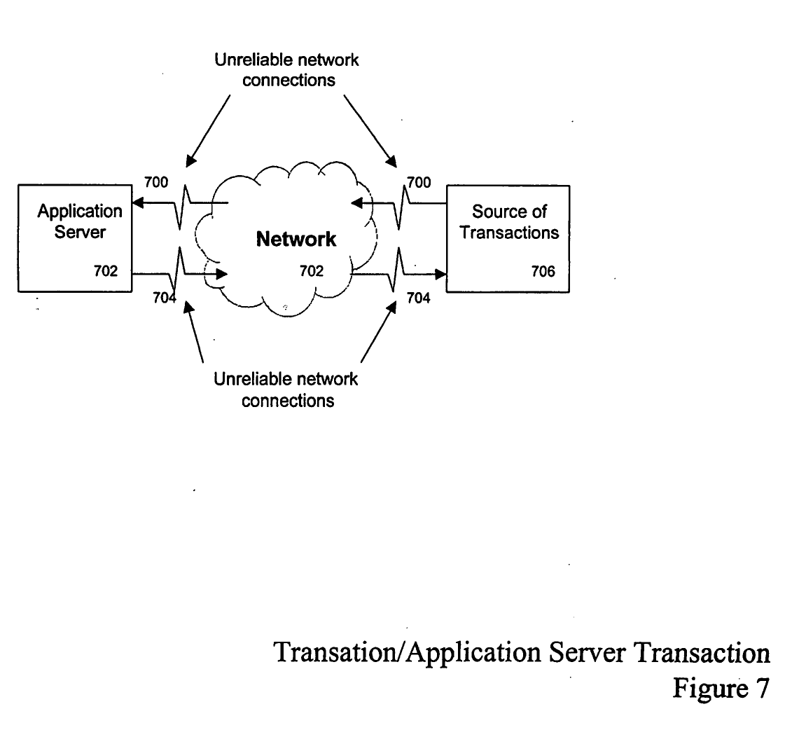

Attention is now turned to a practical application of Space Cells and co-joined Space Cells; that of Application Server transactions. Reference to FIG. 7 shows a simple transaction sequence to an Application Server 702 typical of the Transaction Servers available on networks such as the Internet accepting transactions from a Transaction Source 706, through an unreliable network connection 700. The transaction results are returned to the Transaction Source through unreliable network connections 704. Due to the unreliability of the network connections, the transaction from 706 may never reach the Application Server 702. Since the Application Server can simultaneously accept a plurality of transactions from a plurality of sources, the Application Server may encounter conditions where it cannot accept another transaction resulting in a potentially unwanted or serious condition for the Transaction Source 706. Such lost transactions are commonplace and can cause great problems. What happens in the event that the transaction has not been received or cannot be accepted is dependent on the specific embodiment. In one embodiment, the transaction source 706 simply repeats the transaction request until it is accepted and results are returned. In another embodiment, the transaction is successfully sent to 702 but is not accepted, resulting in a fatal error condition in 706 as it no longer has the conditions that resulted in the transaction request (such situations are typical for wireless and real-time processed events). This is an unsatisfactory situation. Consider now what happens to the result of the transaction. Due to the unreliable nature of the network, it is possible the result may never be received by 706, or that the result cannot be sent to 706 since it has been disconnected for a period of time. Such periodic disconnection are desirable in situations where network bandwidth is monetarily expensive, unreliable or limited in some other way. Examples of such networks are wireless devices, dial-up modem devices, low computational devices, real time situations where processing power is required for activities other than waiting for transaction results. Multiple result re-delivery attempts waste resources in 702 and network bandwidth if 706 is disconnected for an unknown period of time. Clearly, these are unsatisfactory situations for 702 and 706.

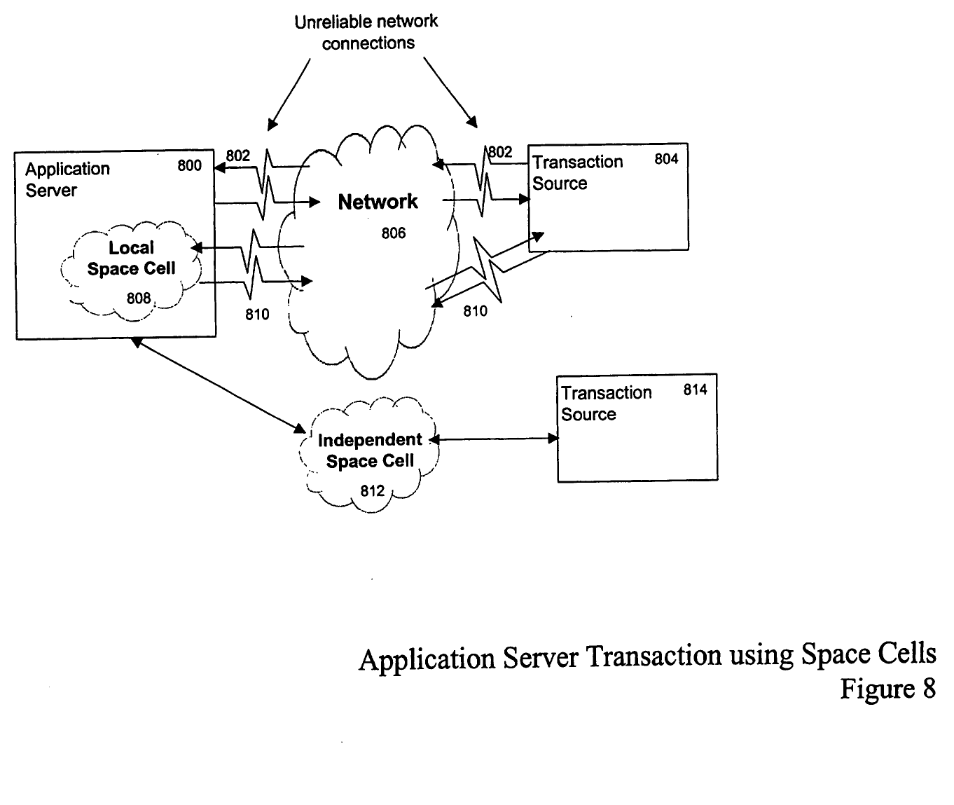

The example shown in FIG. 8 demonstrates how these problems are addressed using Space Cells. Application Server 800 accepts transaction requests from Transaction Sources 804 and 814. Transactions sent via unreliable network connections 802 would suffer from all the problems previously described. However, Transaction Source 804 can use unreliable network connections 810 to write the transaction to Space Cell 808 that is contained within Application Server 800. Even if Transaction Source 804 is disconnected from 800 (whether voluntarily or not) the results of the transaction can still be written to Space Cell 808 for later collection. When ready, Transaction Source 804 can access the transaction result template stored in the Space Cell 808 without the need for a constant connection to the Transaction Source than is required if using network connections 802.

Transaction Source 814 operates in a similar manner, writing transaction templates to Space Cell 812 that is not contained within the Application Server 800. The manner in which Templates written to Space Cell 812 are removed by Application Server 800 is dependent on the specific embodiment. In a preferred embodiment, the Application Server 800 receives a notification from Space Cells 808 and 812 when a template has been written or accessed or another activity has been performed on the Space Cell. In this way the Application Server can handle templates from Space in a more stable, secure and efficient manner compared with asynchronously receiving transaction requests that cannot be delayed. Since the transaction templates are stored in Space, additional Applications Servers can be used to take and process the said templates. By writing the transaction result to a space cell, the transaction requester is able to retrieve the results from space when it is ready rather than having to consume computational and network resources waiting for the transaction result. The number and combination of Application Servers and Space cells is dependent on the specific embodiment and should in no way be considered limited to this example.

Attention is now drawn to a further aspect of the invention relating to the ability of Cells and Cell Servers to correctly operate during increasing volumes of templates, accesses to templates, network unreliabilities and other factors dependent on how the specific embodiments is being used. Such abilities are often referred to as “scaling” and “scalability”. The number of Clervers that can be connected to a cell is limited by such factors as processing power, amount of storage, speed of storage and the reliability and bandwidth of the network connections, although the limitations encountered by embodiments should in no way be considered limited to the aforementioned. There is a practical limitation on the number of Clervers that can be attached to a Cell and the number of Cell accesses that the Cell Server can handle. In an example embodiment, Clervers registering with the Cell consumes 100,000 bytes of memory in the Cell Server. If the Cell Server has 4,000,000 bytes of available memory, a maximum of 40 Clervers can simultaneously register with the cell. Dependant on the specific embodiments, such restrictions are commonplace and should be expected.

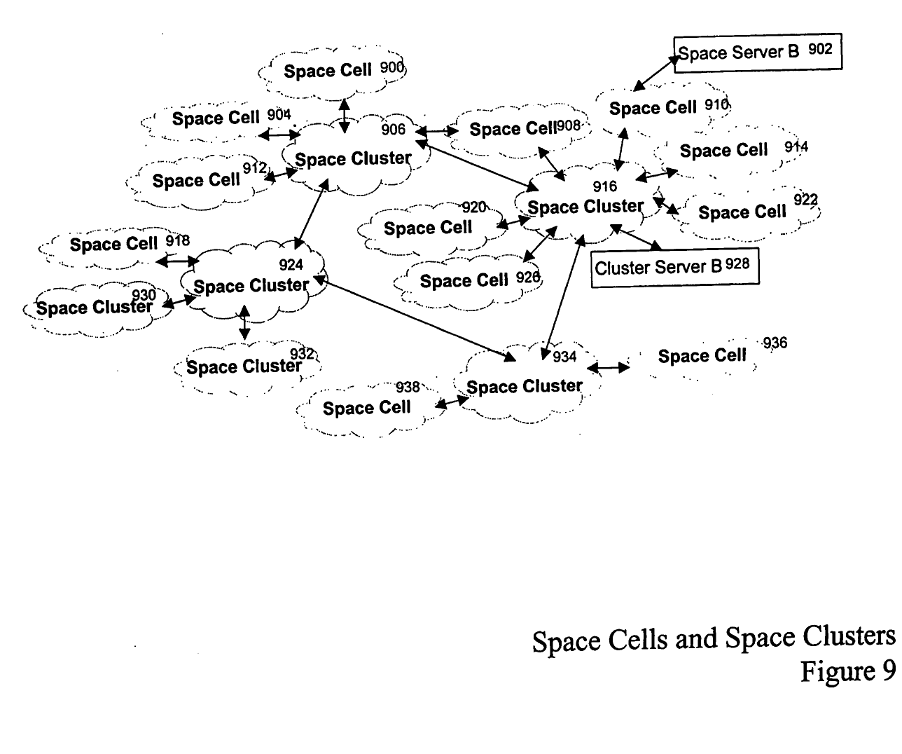

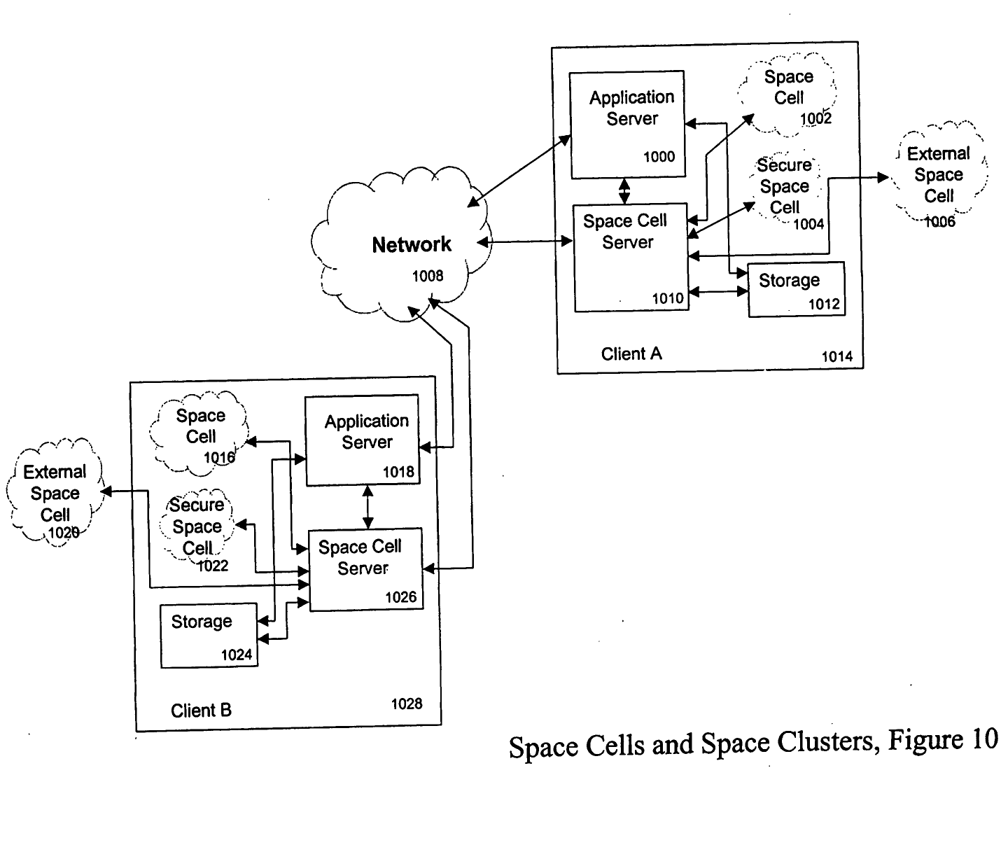

Reference to FIG. 9 shows Space Cells connecting to Space Clusters that in turn connect to other Space Clusters and are connected to by other Space Clusters and other Space Cells. For example, Space Cells 900, 904 and 912 connect to Space Cluster 906 which is itself being connected to by Space Clusters 924 and 908 and connects to Space Cells 924 and 916. Any limit as to nature and number of these interconnections between Space Cells and Space Clusters is dependent on specific embodiments and should in no way be considered limited to this example. Each Space Cluster is controlled by at least one Cluster Server such as is shown in FIG. 9 where Cluster Server 928 controls accesses to Space Cluster 916. The Cluster Servers can optionally act as a Cell Server as well as ensuring that templates written to the Cluster are written or otherwise sent to Clusters attached to the Cell Cluster in accordance with the needs of the specific embodiment. Preferred embodiments have the ability to copy the template, forward the template such that it cannot be accessed from the forwarding cluster as well as performing template filtering and security controls on such transfers.

For example, consider Template T910 written to Cluster 916. Cluster Server 928 optionally applies any filtering or security checks on the template before writing the template to Clusters 934 and 906. In this example, Cluster 906 forwards the template to Cluster 924, although it could have written the template to the Cluster such that is was available to Cells 912, 904 and 900, discarded the template or another such operation as was required by the specific embodiment. Cluster 934 also writes template T910 to Cluster 924, but could have performed other operations on the template prior to the aforementioned write. Cluster 924 receiving another copy of template T910 recognizes that the template is already stored in the cluster and performs such operations as are defined by the specific embodiment. Such operations could include, but should in no way be considered limited to, the notification of a duplicate template to Cluster 934.

In this way, template T910 is made available to a much large number of cells than could be possible if all the cells were attached to Space Server 902. Preferred embodiments use Clusters as a fail-safe device. Since all the clusters have the ability to contain and forward templates to all other clusters the Space Cells can continue to inter-communicate if one of the Clusters is removed. For example, the removal of Space Cluster 934 only affects Cells 938 and 936. Space Cluster 924 can still receive templates through Space Cluster 906. In another embodiment Cell 938 is connected to Space Cluster 924 and Cell 936 is connected to Cluster 916 to enable template access if Space Cluster 924 is removed. In another embodiment, Space Cluster 924 is removed to act independently before optionally reattaching to, for example, Space Cluster 906. Up such reconnection, the stored templates would be re-synchronized as previously described.

Attention is now turned an example Embodiment in the field of secure information transfer. It is well known in the art that password protection and encryption techniques can be broken. Data transmitted on networks can be intercepted by recipients other than the intended recipient. Admittedly there are systems that obsfucate and encrypt data, but such systems do not address the possibility that the transmitted data can miss-directed or intercepted. Clearly, a mechanism that only allowed the intended recipient to access information would provide improved secure data interchange and would be beneficial to both the sender and recipient alike. Reference FIG. 10, Client A 1014 and Client B 1028 establish communication via Network 1008 which in some embodiments establish connections to other similar and dissimilar Clients, Servers and repositories of information such as databases. Clients A and B each comprise Application Server 1000 and 1018, Space Cell Server 1010 and 1026, Internal Space Cells 1002 and 1016 contained within the Client, Secure Space Cells 1004 and 1022 contained within the Client in addition to storage devices 1012, 1024 and connections to Space Cells 1006 and 1020 not contained within Clients A and B. Secure Space Cells 1004 and 1022 contain data for secure transmission and are only accessed by the Space Server contained within the Client. For example, Secure Space Cell 1004 can only be accessed by Space Cell Server 1010 and Secure Space Cell 1022 can only be accessed by Space Cell Server 1026.

Client A wishing to send information to Client B first joins Client B's Internal Space Cell 1016 or External Cell 1020. Client A then writes an Announce Template ‘Ta’ describing the information to be sent into the co-joined Space comprising Cells 1002, 1016, 1020 which will become available to Client B. Client B performs a take operation on template Ta which removes Ta from co-joined Cells. The information contained in template Ta varies between embodiments. For example, in one embodiment, template Ta contains the information to be transferred. In preferred embodiments, the information contained in the template is encrypted and describes to Client B the method and manner in which the information can be obtained, the method and manner of subsequent encryption and other information describing the conditions to be satisfied before the template can be actioned. The contents of the template will vary between embodiments and should not be considered limited to this example. In this example, template Ta instructs Client B to obtain the information from Client A's Secure Cell 1004. Client B requests the information described in Ta from Secure Cell 1004 via Application Server 1000 or Space Cell Server 1010 depending on the specific characteristics of Network 1008. For example, in embodiments where Network 1008 contains an unknown number of firewall devices such as are commonly found on the Internet, the data request is made to Application Server 1000. In embodiments where Network 1008 is a local intranet or subnet with no firewall or other devices impeding Space Cell access, the request is made directly to Space Cell Server 1010. The data request is validated by Application Server 1000 or Space Cell Server 1010 against embodiment specific parameters to determine if the requested data should be sent to Client B from Space Cell 1002, Secure Space Cell 1004, Storage 1012 or Space Cell 1006, the specific storage requirements and location being dependent on the specific embodiment. In some embodiments the data is returned from Space Cells (1002 and 1006) that can be attached to by other Space Cell Servers. Preferred embodiments deliver the data from Space Cells with limited or restricted access such as Cell 1004 and Storage 1012. Other systems and devices could connect to Application Servers 1000 and 1018 and Space Cell Servers 1010 and 1026 to request data and although only two Clients have been shown, the number and nature of the connected devices should in no way be considered limited to this example. In some embodiments, Clients 1014 and 1028 are “trusted applets” or “applets” for the popular Internet Explorer World Wide Web browser from Microsoft. A user wishing to transfer, for example, a document from Client B to Client A “drags” the document to the applet whereupon a visual representation of the document appears in Client B's applet. Client B's user “drags” this document form the applet to instigate secure file transfer.

1. A method to provide particular information from a first computational cell to a second computational cell on the internet, across a firewall, comprising:
by the first computational cell, forming an HTTP message that encapsulates the particular information and sending the HTTP message to the second computational cell via port 80 of the firewall;
by the second computational cell based upon receiving the HTTP message, issuing a MIME message to the first computational cell indicating receipt of the particular information;
by the first computational cell based upon receiving the MIME message, issuing an activate command to the second computational cell; and
by the second computational cell based upon receiving the activate command, utilizing the particular information.

2. A method to provide particular information from a first computational cell to a second computational cell connected to a network, across a firewall comprising:
by the first computational cell, forming a message that encapsulates the particular information and sending the message to the second computational cell;
by the second computational cell, based upon receiving the message, issuing a message to the first computational cell indicating the receipt of the particular information;
by the first computational cell, based upon receiving the message indicating receipt, issuing a message encapsulating an activation command to the second computational cell: and
by the second computational cell, based upon receiving the activate command, utilizing the particular information.

3. The method of claim 1 where the network includes a singular or plurality of firewall or security devices.

4. The method of claim 1, wherein the messages are sent across specific network ports.
